(19) United States
(12) Patent Application Publication
(10) Pub. No.: US 2025/0178294 A1
(43) Pub. Date: Jun. 5, 2025

(54) METHOD FOR MANUFACTURING A PART MADE OF COMPOSITE MATERIAL

(71) Applicant: SAFRAN, Paris (FR)

(72) Inventors: Pierre Jean FAIVRE D'ARCIER, MOISSY-CRAMAYEL (FR); Dominique Marie Christian COUPE, MOISSY-CRAMAYEL (FR); François CHARLEUX, MOISSY-CRAMAYEL (FR); Christophe Marcel Lucien PERDRIGEON, MOISSY-CRAMAYEL (FR)

(73) Assignee: SAFRAN, Paris (FR)

(21) Appl. No.: 18/703,435

(22) PCT Filed: Oct. 20, 2022
(86) PCT No.: PCT/FR2022/051994

§ 371 Date: Apr. 22, 2024

(30) Foreign Application Priority Data
Oct. 22, 2021 (FR) 2111230

(51) Int. Cl. B29C 70/24; B29C 70/08; B29C 70/48; B29K 105/08; B29K 307/04; B29K 309/08; B29L 31/08; F01D 5/28

(52) U.S. Cl. CPC B29C 70/24; B29C 70/083; B29C 70/48; F01D 5/282; B29K 2105/0827; B29K 2105/0845; B29K 2307/04; B29K 2309/08; B29L 2031/08; F05D 2300/6012; F05D 2300/603

(57) ABSTRACT

A method for manufacturing a part made of composite material includes three-dimensionally weaving a structure having a longitudinal axis (A). The method further includes the step of braiding of at least one layer of braiding threads at at least one predetermined angle relative to the longitudinal axis around the woven structure.

### TECHNICAL FIELD OF THE INVENTION

The invention relates to a method for manufacturing a composite material part, in particular a part in the field of aeronautics or renewable energies, such as a spar for a vane subjected to various mechanical stresses.

### TECHNICAL BACKGROUND

The technical background comprises the documents WO-A1-2021/123652, EP-A1-3 553 280, CN-A1-111 469 601, US-A1-2020/071863, U.S. Pat. No. 5,100,713 and DE-A1-10 2018 212442.

Such vanes can be used in the turbomachines, for example the fan vanes, rotating (rotor) vanes, ducted or unducted, with variable or stationary pitch, or in wind turbines.

With reference to FIG. 1, such a vane 2 comprises a skin 4 forming the aerodynamic surface of the vane 2 in contact with the air. The skin 4 forms a pressure side face and a suction side face of the vane connected by a leading edge 6 and a trailing edge 8. The vane extends along a longitudinal axis A between a root 9 and a head 10.

These vanes are advantageously made from composite materials, in particular carbon fibres or threads, to reduce their weight.

The vane 2 also comprises a spar 12 to stiffen the vane and attach it to an engine. The spar 12 extends over a large part of the span of the vane between the pressure side and suction side faces of the skin 4.

A spar of this type is subjected to various mechanical stresses, in particular tension forces along the longitudinal axis, bending forces along an axis perpendicular to the longitudinal axis, and torsional forces about the longitudinal axis.

The spar can be made from any type of material. However, the composite materials also have the advantage of being able to orientate the threads or fibres according to the force applied to the part, in this case the vane.

This type of part is usually made from a unidirectional stack of pre-impregnated threads or long carbon fibres which are placed in a mould with the successive folds oriented differently before compacting and polymerising. Alternatively, such a part can be made from a stack of two-dimensional fabrics, allowing greater thicknesses to be achieved for the same number of folds.

However, as the thickness of the part increases, so does the number of layers of folds. However, the interface between two layers is made up entirely of resin and is therefore an area of mechanical weakness.

It is known to use a three-dimensional (3D) weaving method when the thickness of the part to be manufactured is significant. By interweaving the layers, a 3D fabric allow to guarantee the mechanical integrity of a thick part.

Such a method for 3D weaving a composite material part comprises a weaving of a first part, referred to as the “raw” part, and then consolidating it by injecting and polymerising a resin, for example using a resin transfer moulding (RTM) method. The resulting part is then machined to the desired final geometry. The raw material is formed by weaving strands or warp threads and strands or weft threads. The strands or warp threads are oriented in the longitudinal direction (in the direction of weaving) and extend over several superimposed layers in the vertical direction. The strands or weft threads are oriented in the transverse direction. The thickness bonding or “interlocking” is performed by carrying out a routing of the warp strands between the weft strands.

However, due to the weaving method, it is only possible to have threads or fibres in the weaving plane. In this way, the final part comprises fibres only in these two directions, i.e. fibres oriented perpendicular to each other.

For the strength of a structural part made from a composite material to be optimal, the fibres must be oriented as far as possible in the same direction as the force applied. This means that the warp direction (in the weaving direction) is perfectly suited to a tension and/or bending force. However, these two directions, warp and weft, are not optimal for reinforcing the part against torsional force.

Such strength would require fibres running all the way around the part, which is technically not feasible in 3D weaving.

Another known technique for laying fibres at a specific angle is the braiding. In general, a support referred to as a mandrel is placed in the center of a braiding machine which, by advancing along the mandrel, lays down different fibres with the desired orientations in order to form a part that is resistant to torsion. The support may be hollow, made of foam, or of a material that allows it to be removed once the braid has been consolidated.

Although it is possible to add fibres at 0° to the longitudinal axis of the part in the braid, the mechanical strength of such a part in tension and/or bending is much lower than a part made from 3D woven fabric. This technology may therefore be ideal for a part subject to high torsional stress, but as soon as the forces are multiple and that the tension/bending is no longer negligible, it ceases to be relevant.

Furthermore, this braiding technique does not allow to produce a solid part. As a result, a part of the volume of the part is filled with material that does not contribute to the strength of the part, which is problematic when the overall dimension is critical for a part.

The purpose of the invention is to propose a solution for producing a part optimised for coupled tension, bending and torsional forces.

### SUMMARY OF THE INVENTION

To this end, the invention relates to a method for manufacturing a composite material part, the method comprising:
a three-dimensional weaving of a structure having a longitudinal axis, and
a braiding of at least one layer of braiding threads at at least one predetermined angle relative to the longitudinal axis around the woven structure.

The invention allows to combine the advantages of two methods for shaping composite material fibres: the three-dimensional weaving and braiding methods. The 3D fabric is ideal for thick parts subjected to a tension bending stress. The braid allows to provide circumferential fibres that reinforce the part against torsion. By combining these two methods, it is possible to obtain a part, for example a longitudinal spar, that is resistant to tension and bending but also to torsion.

Advantageously, the invention allows to obtain a part comprising fibres or threads made of composite material both along a main direction of the part, in this case the longitudinal axis of the part, and also around the part.

Advantageously, the braid thickness, as well as its precise orientation, are defined as a function of the ratio between the tension/bending force and the torsional force to which the part must respond.

Preferably, the weaving threads or fibres and/or the braiding threads or fibres are made of carbon or glass.

Advantageously, the predetermined angle of braiding around the woven structure along the longitudinal axis is between 15° and 75°, preferably between 45° and 75°.

Advantageously, the manufacturing method comprises a resin transfer moulding step of the woven structure prior to the braiding step allowing to consolidate the woven structure.

Advantageously, the manufacturing method comprises a resin transfer moulding step after the braiding step to form the part into its final shape.

In one embodiment, the braiding comprises the braiding of at least two layers allowing to obtain the target thickness for the part. In this case, the predetermined angle of the braiding threads of a braiding layer can be different from one braiding layer to another.

In addition, the predetermined angle can advantageously vary along the longitudinal axis during the braiding of a layer, thus allowing predetermined mechanical performances to be obtained. Preferably, the angle along the longitudinal axis can vary between 15° and 75° and even more preferably between 45° and 75°. For example, the predetermined angle of weaving around one segment may be greater than the predetermined angle of weaving around another segment so that the fibres are as close as possible to the circumferential direction of the part. The advantage of adjusting the orientation of the fibres is that the local stiffness of the part can be optimised according to the load it has to support, resulting in a part with greater mass performance. In this way, the different orientations of the braid mean that mechanical performance can be optimised locally.

In another embodiment compatible with the preceding ones, the structure is formed of warp threads and first weft threads and comprises an area formed of warp threads and second weft threads different from the first weft threads. Advantageously, the second weft threads are finer than the first weft threads and the number of second weft threads is smaller than the number of first weft threads, thereby limiting the shrinkage of the warp threads and forming an area that is virtually unidirectional from a mechanical point of view, thereby increasing the stiffness of the part in this area in the warp direction.

The method according to the invention may comprise one or more of the following characteristics, considered independently of one another or in combination with one another:
the angle along the longitudinal axis is between 15° and 75°, and preferably between 45° and 75°,
the angle along the longitudinal axis varies between 15° and 75°, and preferably between 45° and 75°,
the braiding is carried out on and around the woven structure,
the braiding is carried out directly around the woven structure,
the angle is non-zero,
the braiding threads are inclined with respect to the longitudinal axis of the woven structure.

The invention also relates to a composite material part manufactured by the method according to the invention. Such a part thus comprises a woven fibre structure forming the core of the part and a braided fibre skin forming the external profile of the part and extending around the woven fibre structure.

This type of part has a very good tension, bending and torsional strength.

Preferably, the part is a composite material spar for a turbomachine vane.

### BRIEF DESCRIPTION OF THE FIGURES

Further characteristics and advantages of the invention will become apparent from the following detailed description, for the understanding of which reference is made to the attached drawings in which:

FIG. 1, already described, is a schematic side view of a turbomachine vane covered by the invention;

FIG. 2 is a flowchart of a method for manufacturing a composite material part according to the invention;

FIG. 3 is a schematic perspective view of a structure obtained by 3D weaving according to a step in the method of the invention; and

FIG. 4 is a schematic front view of a spar comprising different braid segments.

### DETAILED DESCRIPTION OF THE INVENTION

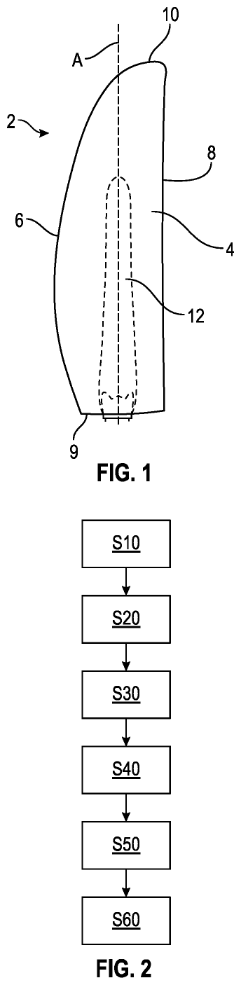

Referring to FIG. 2, a method for manufacturing a composite material part comprises a step S10 of three-dimensional weaving of a structure having a longitudinal axis noted A. In the remainder of the description, the part to be manufactured is a spar for a turbomachine vane such as that shown in FIG. 1. However, the invention can be applied to any part that has to be subjected in tension, bending and torsion, such as parts for renewable energy devices like wind turbines or aeronautical propulsion devices, for example fan vanes, whether rotating (rotor), ducted (fan) or unducted (propeller) and with variable or stationary pitch.

During this 3D weaving step, a 3D woven structure 20 or preform is produced from threads or fibres made of carbon, glass or any other composite material.

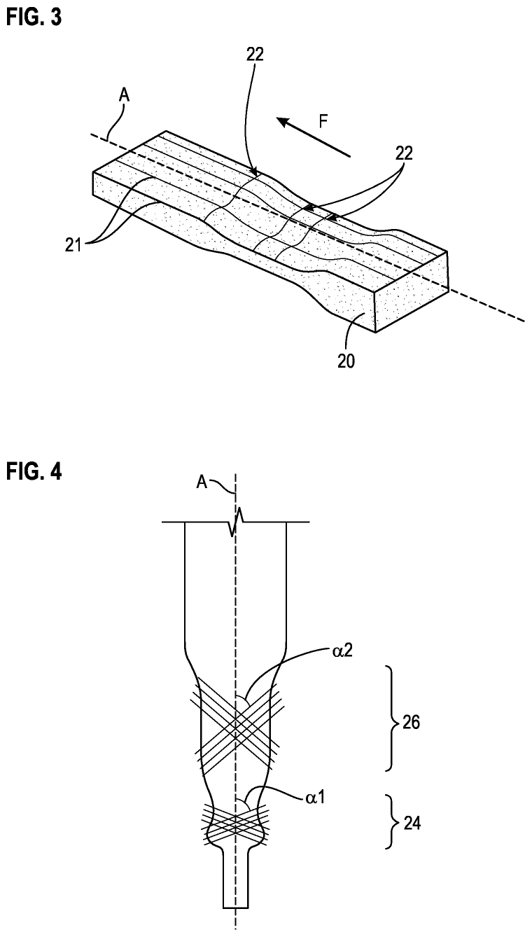

As shown in FIG. 3, this is essentially a conventional weaving with warp strands, threads or fibres 21 running in the span wise direction and weft strands, threads or fibres 22 running around the profile in a substantially perpendicular direction. The preform is woven on an industrial loom. The direction of weaving is indicated by the arrow F. The direction of the warp threads forms the longitudinal direction of the woven structure.

In the 3D woven structure, all the strands, for example of carbon, are woven into each other, by corrugating/entangling the warp threads between the weft threads, to form the fabric that holds the assembly together.

According to one variant, the structure may comprise one or more areas that are quasi-unidirectional from a mechanical point of view, i.e. in which the weft threads are finer and less numerous than in the rest of the structure so that the warp threads are virtually straight, thereby locally increasing the stiffness in the warp direction of the structure.

Advantageously, the method also comprises a step S20 of consolidating the preform obtained by injecting and polymerising a resin to obtain a mechanical strength using a known resin transfer moulding (RTM) method. At the end of this step, the “raw” structure is obtained.

The method also comprises a step S30 of machining the “raw” structure to obtain the geometry on which the braid will be made.

The method also comprises a step S40 of braiding at least one layer of braiding threads at at least one predetermined angle to the longitudinal axis around the woven structure. Advantageously, the predetermined angle of braiding around the woven structure along the longitudinal axis is between 15° and 75°, preferably between 45° and 75°.

The braiding is carried out using carbon or glass threads or fibres on an industrial braiding machine.

The consolidated and machined 3D woven structure is then placed in a braiding machine to add braid to its external surface. In this way, the woven structure acts as a mandrel for the braiding.

Several layers may be necessary to obtain the target thickness of the part to be produced. The braiding parameters must be defined as a function of the thickness and orientation of the fibres in question, i.e. as a function of the ratio between the tension/bending force and the torsional force to which the part must respond.

Advantageously, the predetermined angle of the braiding threads relative to the longitudinal axis of the structure can be different from one braiding layer to another.

In addition, the predetermined angle can advantageously vary along the longitudinal axis during the braiding of a layer, thus allowing predetermined mechanical performances to be obtained. Advantageously, the angle along the longitudinal axis can vary between 15° and 75° and preferably between 45° and 75°.

According to the example of a spar manufactured according to this embodiment and illustrated in FIG. 4, the predetermined angle α1 of weaving around a lower segment 24 intended to be close to the root 9 of the vane, is advantageously greater than the predetermined angle α2 of weaving around an upper segment 26, intended to be closer to the head 10 of the vane than the lower segment 24, thus allowing the fibres of the lower portion to be as close as possible to the circumferential direction of the part. The lower segment, which is intended to be close to the vane root, will be subjected mainly to circumferential compression. This will be partially compensated for by the circumferential orientation of the braid in this segment.

In this way, the orientation of the fibres allows the local stiffness of the part to be optimised according to the load it has to support, resulting in a part with greater mass performance.

Alternatively, the orientation of the braid threads or fibres can of course remain constant along the longitudinal axis of the part in order to simplify the manufacturing method or when the distribution of the forces is uniform over the part.

Preferably, the method continues with a step S50 of consolidating the braid obtained by injecting and polymerising a resin to obtain a mechanical strength using the resin transfer moulding (RTM) method.

Preferably, the method comprises a further step S60 of machining the consolidated part to obtain the final geometry of the part.

The method described in the embodiment comprises two resin injection steps: one to consolidate the woven structure and the other to consolidate the braid.

In one variant, the method comprises a single resin injection step, allowing to reduce the manufacturing time and costs. In this case, the method comprises a step to stiffen the woven structure so that it can be machined, for example by adding a tackifier to the structure.

1. A method for manufacturing a composite material part, the method comprising the steps of:
weaving three dimensionally a structure having a longitudinal axis, and
braiding at least one layer of braiding threads at at least one predetermined angle relative to the longitudinal axis around the structure.

2. The method according to claim 1, further comprising a step of resin transfer molding the woven structure prior to the braiding step.

3. The method according to claim 1, further comprising a step of resin transfer molding after the braiding step to form the part with a final shape.

4. The method according to claim 1, wherein the braiding comprises braiding at least two layers and wherein the predetermined angle of the braiding threads of one braiding layer is different from one braiding layer to another.

5. The method according to claim 1, wherein the angle along the longitudinal axis is between 15° and 75°.

6. The method according to claim 1, wherein the predetermined angle varies along the longitudinal axis during the braiding of a layer.

7. The method according to claim 6, wherein the angle along the longitudinal axis varies between 15° and 75°.

8. The method according to claim 6, wherein the woven structure comprises a first segment and a second segment and wherein for a braiding layer the predetermined angle (α1) of weaving about the second segment is greater than the predetermined angle (α2) of weaving about the first segment.

9. The method according to claim 1, wherein the structure is formed of warp threads and first weft threads and comprises an area formed of warp threads and second weft threads and wherein the second weft threads are finer than the first weft threads and the number of second weft threads is smaller than the number of first weft threads.

10. The method according to claim 1, wherein the weaving threads and/or the braiding threads are carbon or glass.

11. A composite material part manufactured by the method according to claim 1, the part being a composite material spar for a turbomachine vane.

12. The method according to claim 7, wherein the angle along the longitudinal axis varies between 45° and 75°.
